(19) United States
(12) Patent Application Publication
(10) Pub. No.: US 2020/0134593 A1
(43) Pub. Date: Apr. 30, 2020

(54) SYSTEMS AND METHODS FOR MULTICOMPUTER DATA TRANSFERRING IN RESPONSE TO INPUT FROM A USER DEVICE

(71) Applicant: Capital One Services, LLC, McLean, VA (US)

(72) Inventor: Arun PANNEERSELVAM, Henrico, VA (US)

(73) Assignee: Capital One Services, LLC, McLean, VA (US)

(21) Appl. No.: 16/176,185

(22) Filed: Oct. 31, 2018

(51) Int. Cl. G06Q 20/22; G06Q 20/40; H04L 12/741; H04L 29/06

(52) U.S. Cl. CPC G06Q 20/29; H04L 69/22; H04L 45/74; G06Q 20/40

(57) ABSTRACT

The present disclosure relates to systems and methods for multicomputer data transferring in response to user input. In one implementation, a system for multicomputer data transferring may include at least one server configured to: receive, from a first user device, a command to transfer a portion of a transaction associated with a first user to a second user; in response to the command, transmit an inquiry to a second user device; receive, from the second user device and in response to the inquiry, an authorization for transfer; determine, based on the command and the authorization, a server associated with the second user; assemble a data packet representing the portion of the transaction; transmit the data packet across a computer network to the determined server; and update a record associated with the first user and stored on the at least one server to reflect the transferred portion.

### TECHNICAL FIELD

The present disclosure relates generally to the field of multicomputer data transferring. More specifically, and without limitation, this disclosure relates to systems and methods for moving records associated with a transaction between servers in response to user input.

### BACKGROUND

In many interactions, a person may need to divide a single transaction between a number of persons. Conventionally, a manual exchange of tangible currency occurred in order to divide the transaction. Alternatively, a manual division of the transaction itself, such as splitting of a restaurant check, may be used to divide the transaction.

With the advent of cashless payment methods, such as credit cards, mobile pay, and the like, these manual techniques became more cumbersome. For example, the merchant either has to process a plurality of cashless sub-transactions for a single transaction, or the persons have to exchange tangible currency with a single person who uses a cashless method for the entire transaction.

One automated solution to this problem arose from apps such as Splitwise®, Venmo®, Zelle®, or the like. Such apps allow users to send money to and request money from other users. However, there are drawbacks to these automated solutions. First, these solutions allow for cashless division of a transaction but still rely on manual interactions between persons to divide a transaction. Second, these solutions still require persons to exchange intangible currency with a single person who used a cashless method for the entire transaction. Accordingly, conventional techniques remain manual and subjective, as well as reducing a user's experience because the perceived improvement of the apps is negligible compared with manual exchange of tangible currency.

Conventional techniques also suffer from a need for users to utilize the same application or otherwise have accounts or memberships with the same website. Accordingly, a user's experience may be degraded because she cannot share a transaction with another individual not using the same application or belonging to the same website. Moreover, this incurs further manual costs to performing the sharing.

Furthermore, modern cashless payment techniques often provide payment protections, rewards, and other incentives to a user thereof. However, extant techniques for dividing transactions bundles these incentives with a single purchaser. In other words, conventional techniques do not provide a mechanism for other persons involved in the divided transaction to automatically claim a proportional share of incentives. Indeed, the problem is exacerbated if the other persons have a cashless payment method that provides bonus incentives, for example, depending on the type of transaction. These bonus incentives are fully sacrificed under conventional techniques for division. The lack of incentive sharing and dissolution of possible bonus incentives further reduces a user's experience with extant automated sharing systems.

### SUMMARY

In view of the foregoing, embodiments of the present disclosure describe systems and methods for using multicomputer data transferring to overcome technical limitations of transaction transfers and to provide improved user experiences regarding the same. In particular, the provided systems and methods use multicomputer data transferring in order to automate the previously manual and subjective process of dividing a transaction between users. Moreover, the provided systems and methods use multicomputer data transferring in order to improve users' experiences as compared with conventional automated methods of transaction splitting. For example, the provided systems and methods allow for automated division of the transaction amongst differing payment methods associated with the users, eliminating manual exchanges of currency, whether using cash or cashless exchanges, and allowing each user to apply her preferred payment method to a portion of the transaction.

In one embodiment, a system for multicomputer data transferring in response to user input may comprise at least one server. The at least one server may comprise at least one memory storing instructions and at least one processor configured to execute the instructions to perform operations. The operations may comprise receiving, from a first user device, a command to transfer a portion of a transaction associated with a first user of the first user device to a second user; in response to the command, transmitting an inquiry to a second user device associated with the second user; receiving, from the second user device and in response to the inquiry, an authorization for transfer; determining, based on the command and the authorization, a server associated with the second user; assembling a data packet representing the portion of the transaction and addressing the data packet to the determined server; transmitting the data packet across at least one computer network to the determined server; and updating a record associated with the first user and stored on the at least one server of the system to reflect the transferred portion of the transaction.

In one embodiment, a system for multicomputer data transferring in response to user input may comprise at least one server. The at least one server may comprise at least one memory storing instructions and at least one processor configured to execute the instructions to perform operations. The operations may comprise receiving, from a server associated with a first user, a data packet representing a portion of a transaction for transferring to a second user from the first user; in response to the data packet, confirming the second user has authorized the transfer; determining, based on the data packet and the authorization, a record associated with the second user; updating the determined record based on the data packet such that the determined record reflects the transferred portion of the transaction; assembling a confirmatory data packet and addressing the confirmatory data packet to the server associated with the first user; and transmitting the confirmatory data packet across at least one computer network to the server associated with the first user.

In one embodiment, a user device for causing multicomputer data transferring may comprise at least one memory storing instructions and at least one processor configured to execute the instructions to perform operations. The operations may comprise receiving, from a user of the user device, a command to transfer a portion of a transaction associated with the user to a second user; in response to the command, generating a data packet encapsulating command for the transfer; determining, based on the command and the portion, a server associated with the user and including, in at least one record, the transaction; transmitting the data packet across at least one computer network to the determined server; and after transmitting the data packet, receiving a confirmatory data packet from the determined server, the confirmatory data packet indicating completion of the requested transfer.

In one embodiment, a system for multicomputer data transferring in response to user input may comprise at least one server. The at least one server may comprise at least one memory storing instructions and at least one processor configured to execute the instructions to perform operations. The operations may comprise receiving a transaction associated with a first user of a first user device; retrieving, from a server storing a calendar associated with the first user, one or more events within a range of a date and time of the received transaction; identifying, using the one or more events, one or more possible second users for sharing the received transaction; transmitting inquiries to one or more second user devices associated with the one or more possible second users, the inquiries including a total of the received transaction; receiving, from at least one second user device associated with at least one second user and in response to the inquiries, an authorization for transfer, the authorization including an indicator of a portion of the transaction; determining, based on the authorization, a server associated with the at least one second user; assembling a data packet representing the portion of the transaction and addressing the data packet to the determined server; transmitting the data packet across at least one computer network to the determined server; and updating a record associated with the first user and stored on the at least one server of the system to reflect the transferred portion of the transaction.

In one embodiment, a system for multicomputer data transferring in response to user input may comprise at least one server. The at least one server may comprise at least one memory storing instructions and at least one processor configured to execute the instructions to perform operations. The operations may comprise receiving, from a user device associated with the first user, an authorization including an indicator of a portion of a transaction for transferring from a second user to the first user; in response to and based on the authorization, determining a server associated with the second user and a record associated with the first user; updating the determined record based on the authorization such that the determined record reflects the transferred portion of the transaction; assembling a confirmatory data packet and addressing the confirmatory data packet to the determined server; and transmitting the confirmatory data packet across at least one computer network to the server associated with the second user.

In one embodiment, a user device for causing multicomputer data transferring may comprise at least one memory storing instructions and at least one processor configured to execute the instructions to perform operations. The operations may comprise transmitting, to a server associated with the user device, a command to authorize a transaction to an account associated with a first user; transmitting an authorization to the server to access a calendar associated with the first user stored on another sever; receiving an inquiry relating at least one event on the calendar with the transaction; transmitting confirmation in response to the inquiry to the server; and receiving confirmation from the server, the confirmation indicating sharing of the transaction with one or more users associated with the at least one event.

In some embodiments, the present disclose describes non-transitory, computer-readable media for causing one or more processors to execute methods consistent with the present disclosure.

It is to be understood that the foregoing general description and the following detailed description are example and explanatory only, and are not restrictive of the disclosed embodiments.

### BRIEF DESCRIPTION OF THE DRAWINGS

The accompanying drawings, which comprise a part of this specification, illustrate several embodiments and, together with the description, serve to explain the principles disclosed herein. In the drawings:

FIG. 1 is a block diagram of a system for implementing multicomputer data transfers in response to user commands, according to an example embodiment of the present disclosure.

FIG. 2 is a block diagram of a multicomputer exchange between two servers, according to an example embodiment of the present disclosure.

FIG. 3A is a flowchart of an example method for multicomputer data transferring in response to user input as executed by a sending server, according to an example embodiment of the present disclosure.

FIG. 3B is a flowchart of an example method for automatic multicomputer data transferring executed by a sending server, according to an example embodiment of the present disclosure.

FIG. 4A is a flowchart of an example method for multicomputer data transferring in response to user input as executed by a receiving server, according to an example embodiment of the present disclosure.

FIG. 4B is a flowchart of an example method for automatic multicomputer data transferring as executed by a receiving server, according to an example embodiment of the present disclosure.

FIG. 5A is a flowchart of an example method for causing multicomputer data transferring using a user device, according to an example embodiment of the present disclosure.

FIG. 5B is a flowchart of an example method for authorizing automated multicomputer data transferring using a user device, according to an example embodiment of the present disclosure.

FIG. 6 is a block diagram of an example server with which the systems, methods, and apparatuses of the present disclosure may be implemented.

FIG. 7A is a block diagram of an example user device with which the systems, methods, and apparatuses of the present disclosure may be implemented.

FIG. 7B is a side view of the example user device of FIG. 7A.

### DETAILED DESCRIPTION

The disclosed embodiments relate to systems and methods for causing multicomputer data transfer in response to user input. Embodiments of the present disclosure may be implemented using a general-purpose computer. Alternatively, a special-purpose computer may be built according to embodiments of the present disclosure using suitable logic elements.

Advantageously, disclosed embodiments may provide improved user experiences with division of transactions as compared with conventional automated and manual techniques. Moreover, disclosed embodiments may use rules to automate conventional, manual processes of transaction division. Finally, disclosed embodiments may solve the technical problem of shifting transactions across servers operated by different institutions.

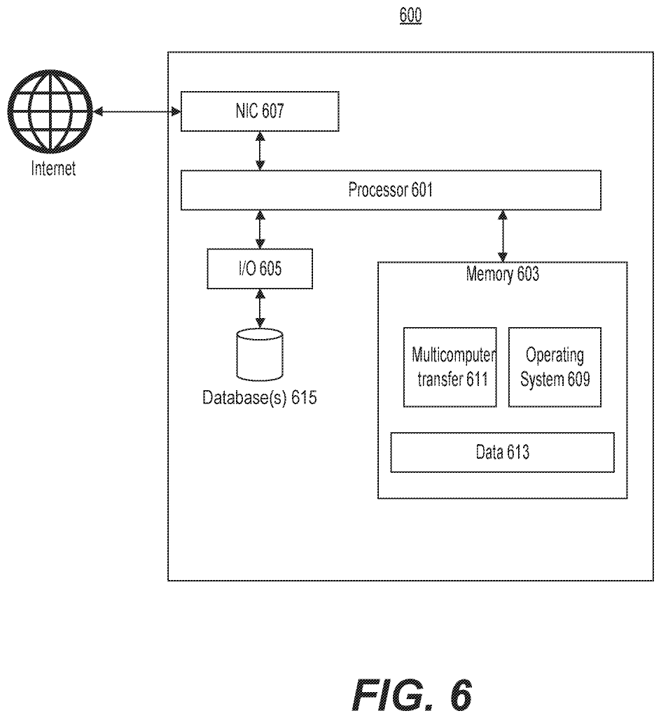

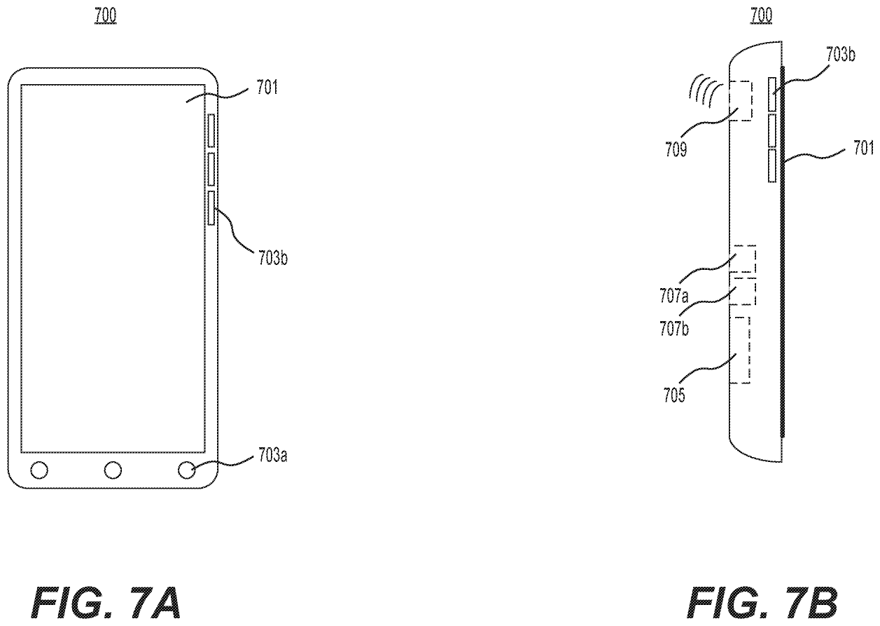

According to an aspect of the present disclosure, a user device (e.g., user device 700 of FIGS. 7A and 7B) may cause a multicomputer data transfer between at least one server (e.g., server 600 of FIG. 6) associated with a first set of records and at least one other server (e.g., server 600 of FIG. 6) associated with a second set of records. In one example, the at least one server may receive, from a first user device, a command to transfer a portion of a transaction associated with a first user of the first user device to a second user. For example, the command may comprise one or more data packets transmitted from the first user device (e.g., using a network interface controller (NIC)) across one or more computer networks (e.g., a local area network (LAN), the Internet, or the like) to the at least one server (e.g., where it is received using an NIC). The command may represent input received by the first user device from a user associated therewith, e.g., entered using a touchscreen or other input device forming a part of the first user device. In some embodiments, an application executed by the first user device may generate the data packet(s) based on the command. In such embodiments, the data packet(s) may comprise an application programming interface (API) call to an application executed by the at least one server.

In response to the command, the at least one server may transmit an inquiry to a second user device associated with the second user. For example, the inquiry may comprise one or more data packets transmitted from the at least one server (e.g., using an NIC) across one or more computer networks (e.g., a LAN, the Internet, or the like) to the second user device (e.g., where it is received using an NIC). In some embodiments, an application executed by the at least one server may generate the data packet(s) based on the command. In some embodiments, the data packet(s) may comprise an API call to an application executed by the second user device. The API call may cause a push alert, graphical alert, and/or other alert to be displayed to the second user, requesting authorization of the requested transfer.

Accordingly, the at least one server may receive, from the second user device and in response to the inquiry, an authorization for transfer. For example, the authorization may comprise one or more data packets transmitted from the first user device (e.g., using an NIC) across one or more computer networks (e.g., a local area network (LAN), the Internet, or the like) to the at least one server (e.g., where it is received using an NIC). The authorization may represent input received by the second user device from the second user associated therewith, e.g., entered using a touchscreen or other input device forming a part of the second user device. For example, the input may be received in response to the push alert, graphical alert, and/or other alert displayed to the second user in response to receipt of the inquiry from the at least one server. In some embodiments, an application executed by the second user device may generate the data packet(s) based on the authorization. In such embodiments, the data packet(s) may comprise an API call to an application executed by the at least one server.

The at least one server may determine, based on the command and the authorization, a server associated with the second user. For example, the command may include an identifier of the second user and the authorization may include a selection of a record stored on the determined server for updating to reflect the transfer.

In some embodiments, the at least one server may further determine, based on an identity of the second user, whether the second user has an associated record of a first type; when the second user has an associated record of the first type, determine a first set of records of the first type stored on the determined server for updating to reflect the transfer; and when the second user does not have an associated record of the first type, determine a second set of records not of the first type stored on the determined server for updating to reflect the transfer. The first set of records of the first type may represent a plurality of accounts having an associated account servicer that is the same as an associated account servicer of an account represented by the record associated with the first user. Similarly, the second set of records not of the first type may represent a plurality of accounts having an associated account servicer that is not the same as an associated account servicer of an account represented by the record associated with the first user. Alternatively, the determined server may perform these steps, as further explained below.

The at least one server may assemble a data packet representing the portion of the transaction and address the data packet to the determined server. For example, the data packet may comprise an API call to an application executed by the determined server. The at least one server may transmit the data packet across at least one computer network to the determined server. In some embodiments, the assembled data packet may include a header including an address of the determined server and a body including an indicator of the selected record and an indicator of the portion of the transaction. Additionally or alternatively, the assembled data packet may include an authentication of the at least one server. For example, the authentication may comprise an authentication provided by the second user in the authorization and/or an authentication previously provided from the determined server to the at least one server. Accordingly, the authentication may comprise a password, biometric, key, or other credential provided by the second user or retrieved by the at least one server based on input from the second user. Alternatively, the authentication may comprise a certification, key, or other credential maintained by the at least one server and evidencing a credentialed relationship between the at least one server and the determined server.

Additionally with or alternatively to the at least one server sending the inquiry, the determined server may send an inquiry to the second user device and receive an authorization therefrom, as further explained below. In such embodiments, the determined server may be determined based only on the command rather than the command and the authorization.

In some embodiments, the at least one server may receive a confirmatory data packet from the determined server. For example, the confirmatory data packet may confirm that at least one record associated with the second user was updated to reflect the transferred portion of the transaction, as further explained below.

The at least one server may update a record associated with the first user and stored on the at least one server of the system to reflect the transferred portion of the transaction. For example, the record may be associated with an account of the first user. Accordingly, the record may be updated by removing the transferred portion of the transaction from the account. For example, an amount of the transaction as stored in the record may be reduced by the portion of the transaction. Additionally or alternatively, a data structure defining the portion of the transaction that was transferred may be appended to the record. In some embodiments, the record may be updated in response to receipt of the confirmatory data packet from the determined server.

In some embodiments, the at least one server may send a confirmatory data packet to the first user device. For example, the confirmation data packet may comprise an API call to an application executed by the first user device and may cause a push alert, graphical alert, and/or other alert to be displayed to the first user, confirming that the portion was transferred.

A corresponding series of steps may be performed by the determined server. For example, the determined server may comprise at least one server that receives, from a server associated with a first user, a data packet representing a portion of a transaction for transferring to a second user from the first user. For example, the data packet(s) may be transmitted from the server associated with the first user (e.g., using a network interface controller (NIC)) across one or more computer networks (e.g., a local area network (LAN), the Internet, or the like) to the at least one server (e.g., where it is received using an NIC). In some embodiments, an application executed by the server associated with the first user may generate the data packet(s) based on a command from a first user device. In such embodiments, the data packet(s) may comprise an application programming interface (API) call to an application executed by the at least one server.

In response to the data packet(s), the at least one server may confirm the second user has authorized the transfer. For example, the at least one server may verify an authorization included in the data packet(s). As explained above, the authorization may comprise a credential associated with the second user. For example, the credential may be included in the data packet(s).

In some embodiments, the confirmation may comprise generating an inquiry and transmitting the inquiry to a second user device associated with the second user and receiving, from the second user device and in response to the inquiry, the authorization. For example, the inquiry may comprise one or more data packets transmitted from the at least one server (e.g., using an NIC) across one or more computer networks (e.g., a LAN, the Internet, or the like) to the second user device (e.g., where it is received using an NIC). Similarly, the authorization may comprise one or more data packets transmitted from the second user device (e.g., using an NIC) across one or more computer networks (e.g., a LAN, the Internet, or the like) to the at least one server (e.g., where it is received using an NIC). In some embodiments, an application executed by the second user device may generate the data packet(s) comprising the inquiry based on the command. In some embodiments, the data packet(s) comprising the inquiry may comprise an API call to an application executed by the second user device. The API call may cause a push alert, graphical alert, and/or other alert to be displayed to the second user, requesting authorization of the requested transfer. Similarly, an application executed by the second user device may generate the data packet(s) comprising the authorization based on the authorization. In such embodiments, the data packet(s) comprising the inquiry may comprise an API call to an application executed by the at least one server.

As explained above, the authorization may include an authentication associated with the second user. For example, the authentication may comprise an authentication input by the second user into the second user device and/or an authentication relationship previously established between an application executed by the second user device and the at least one server.

The at least one server may determine, based on the data packet and the authorization, a record associated with the second user. For example, the data packet may include an identifier of the second user, and the authorization may include a selection of a record stored on the determined server for updating to reflect the transfer.

As explained above, in some embodiments, the at least one server may further determine, based on an identity of the second user, whether the first user has an associated record of a first type; when the second user has an associated record of the first type, select the associated record of the first type as the determined record; and when the second user does not have an associated record of the first type, select an associated record not of the first type as the determined record. The first type may comprise accounts having an associated account servicer that is the same as an associated account servicer of an account associated with the first user from which the transfer originated. Similarly, the second type may comprise accounts having an associated account servicer that is not the same as an associated account servicer of an account associated with the first user from which the transfer originated.

The at least one server may update the determined record based on the data packet such that the determined record reflects the transferred portion of the transaction. For example, the record may be associated with an account of the second user. Accordingly, the record may be updated by adding the transferred portion of the transaction from the account. In some embodiments, the record may be updated in response to receipt of the authorization from the second user device.

The at least one server may assemble a confirmatory data packet and address the confirmatory data packet to the server associated with the first user. In some embodiments, the confirmatory data packet may be configured to cause the server associated with the first user to transmit a confirmation to a first user device associated with the first user, as explained above. The at least one server may transmit the confirmatory data packet across at least one computer network to the server associated with the first user.

In some embodiments, the at least one server may send a confirmatory data packet to the first user device. For example, the confirmation data packet may comprise an API call to an application executed by the first user device and may cause a push alert, graphical alert, and/or other alert to be displayed to the first user, confirming that the portion was transferred.

In some embodiments, the at least one server may send a confirmatory data packet to the second user device. For example, the confirmation data packet may comprise an API call to an application executed by the second user device and may cause a push alert, graphical alert, and/or other alert to be displayed to the second user, confirming that the portion was transferred.

Alternatively, the multicomputer data transferring described above may occur automatically rather than requiring a command from a first user. For example, at least one server (e.g., server 600 of FIG. 6) may receive a transaction associated with a first user of a first user device. The first user device may transmit a request including details regarding the transaction, such as an amount, an account associated with the first user, or the like, to the at least one server for verification and processing. In some embodiments, a credential of the first user may be included in the request.

The at least one server may retrieve, from a server storing a calendar associated with the first user, one or more events within a range of a date and time of the received transaction. For example, the first user may have previously authorized the at least one server to retrieve the events, e.g., by providing a password, key, certificate, or other credential such that the at least one server may access the server storing the calendar. Alternatively, the at least one server may transmit an inquiry to the first user device, and the first user device may transmit an authorization to retrieve the events in response to the inquiry.

Using the one or more events, the at least one server may identify one or more possible second users for sharing the received transaction. For example, the at least one server may extract invitees from the one or more events; names, email addresses, phone numbers, or the like from text associated with the one or more events; or the like.

The at least one server may transmit inquiries to one or more second user devices associated with the one or more possible second users. For example, the inquiries may comprise an API call to an application executed by the one or more second user devices. The API call may cause a push alert, graphical alert, and/or other alert to be displayed to the one or more possible second users. Additionally or alternatively, the at least one server may transmit inquiries as emails, text messages, or the like, to the one or more second user devices. In some embodiments, the at least one server may send an API to any possible second users registered as executing the application on a second user device and send an email, text message, or the like to any possible second users not registered as executing the application. The inquiries may include a total of the received transaction.

The at least one server may receive, from at least one second user device associated with at least one second user and in response to the inquiries, an authorization for transfer. The authorization may include an indicator of a portion of the transaction. Based on the authorization, the at least one server may determine a server associated with the at least one second user. For example, the authorization may include a selection of an account associated with the at least one second user, and the at least one server may determine the server based on where a record associated with the account is stored.

The at least one server may assemble a data packet representing the portion of the transaction and address the data packet to the determined server. In some embodiments, the assembled data packet may include a header including an address of the determined server and a body including an indicator of a record of an account associated with the at least one second user and an indicator of the portion of the transaction. Additionally or alternatively, the assembled data packet may include an authentication of the at least one server. The at least one server may transmit the data packet across at least one computer network to the determined server.

In some embodiments, the at least one server may receive a confirmatory data packet from the determined server. For example, the confirmatory data packet may confirm that at least one record associated with the at least one second user was updated to reflect the transferred portion of the transaction, as further explained below.

The at least one server may update a record associated with the first user and stored on the at least one server of the system to reflect the transferred portion of the transaction. For example, the record may be associated with an account of the first user. Accordingly, the record may be updated by removing the transferred portion of the transaction from the account. For example, as explained above, an amount of the transaction as stored in the record may be reduced by the portion of the transaction and/or a data structure defining the portion of the transaction that was transferred may be appended to the record. In some embodiments, the record may be updated in response to receipt of the confirmatory data packet from the determined server.

In some embodiments, the at least one server may send a confirmatory data packet to the first user device. For example, the confirmation data packet may comprise an API call to an application executed by the first user device and may cause a push alert, graphical alert, and/or other alert to be displayed to the first user, confirming that the portion was transferred.

A corresponding series of steps may be performed by the determined server. For example, the determined server may comprise at least one server that receives, from a user device associated with the first user, an authorization including an indicator of a portion of a transaction for transferring from a second user to the first user. The user device may generate the authorization in response to an inquiry from a server associated with the second user, as described above.

In response to and based on the authorization, the at least one server may determine a server associated with the second user and a record associated with the first user. For example, the authorization may include a selection of an account associated with the second user, and the at least one server may determine the server based on where a record associated with the account is stored.

The at least one server may update the determined record based on the authorization such that the determined record reflects the transferred portion of the transaction. For example, the record may be associated with an account of the second user. Accordingly, the record may be updated by adding the transferred portion of the transaction from the account.

The at least one server may assemble a confirmatory data packet and addressing the confirmatory data packet to the determined server. In some embodiments, the confirmatory data packet may be configured to cause the determined server to transmit a confirmation to a second user device associated with the second user, as explained above. The at least one server may transmit the confirmatory data packet across at least one computer network to the server associated with the second user.

In some embodiments, the at least one server may send a confirmatory data packet to the first user device. For example, the confirmation data packet may comprise an API call to an application executed by the first user device and may cause a push alert, graphical alert, and/or other alert to be displayed to the first user, confirming that the portion was transferred.

In any of the embodiments described above, a user device associated with the first user may initiate the multicomputer data transferring. In some embodiments, such a user device may receive, from a user of the user device, a command to transfer a portion of a transaction associated with the user to a second user. For example, the command may be entered using a touchscreen or other input device forming a part of the user device.

In response to the command, the user device may generate a data packet encapsulating command for the transfer. For example, the data packet may include an indicator of the portion of the transaction.

The user device may determine, based on the command and the portion, a server associated with the user and including, in at least one record, the transaction. For example, the command may include an identifier of an account associated with the user, which may be used to determine the server storing the at least one record associated with the account. Additionally or alternatively, the portion may include an identifier of the transaction, which may be used to determine the server storing the at least one record including the transaction.

The user device may transmit the data packet across at least one computer network to the determined server. After transmitting the data packet, the user device may receive a confirmatory data packet from the determined server, the confirmatory data packet indicating completion of the requested transfer. For example, the confirmation data packet may comprise an API call to an application executed by the first user device and may cause a push alert, graphical alert, and/or other alert to be displayed to the first user, confirming that the portion was transferred.

Alternatively, as described above, a user device may be used to automate sharing of a transaction. For example, the user device may transmit, to a server associated with the user device, a command to authorize a transaction to an account associated with a first user. The command may comprise one or more data packets transmitted from the user device (e.g., using a network interface controller (NIC)) across one or more computer networks (e.g., a local area network (LAN), the Internet, or the like) to the server (e.g., where it is received using an NIC). The command may represent input received by the user device from a user associated therewith, such as the first user, e.g., entered using a touchscreen or other input device forming a part of the first user device.

The user device may transmit an authorization to the server to access a calendar associated with the first user stored on another sever. For example, the authorization may include an authentication associated with the first user. The authentication may comprise an authentication input by the first user and/or an authentication relationship previously established between the server and the other server.

The user device may receive an inquiry relating at least one event on the calendar with the transaction. For example, the inquiry may comprise one or more data packets transmitted from the server (e.g., using an NIC) across one or more computer networks (e.g., a LAN, the Internet, or the like) to the user device (e.g., where it is received using an NIC). In some embodiments, the data packet(s) may comprise an API call to an application executed by the user device. The API call may cause a push alert, graphical alert, and/or other alert to be displayed to a user of the user device (e.g., the first device), requesting confirmation of the relation.

The user device may transmit confirmation in response to the inquiry to the server. For example, the confirmation may comprise one or more data packets transmitted from the user device (e.g., using an NIC) across one or more computer networks (e.g., a LAN, the Internet, or the like) to the server (e.g., where it is received using an NIC). The confirmation may represent input received by the user device from a user associated therewith, such as the first user, e.g., entered using a touchscreen or other input device forming a part of the first user device. For example, the inquiry may cause a push alert, graphical alert, and/or other alert to be displayed to a user of the user device (e.g., the first device), and the user may enter input in response to the alert that is used by the user device to generate the confirmation.

The user device may receive confirmation from the server, the confirmation indicating sharing of the transaction with one or more users associated with the at least one event. For example, the confirmation may comprise an API call to an application executed by the user device and may cause a push alert, graphical alert, and/or other alert to be displayed to a user of the user device (e.g., the first user), confirming sharing of the transaction.

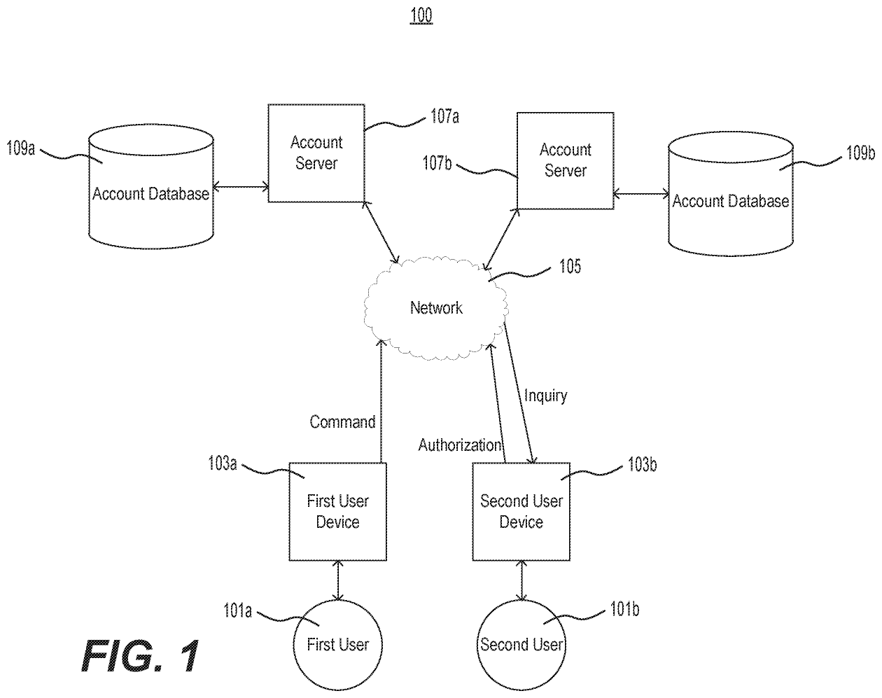

FIG. 1 is a block diagram of a system 100 for implementing multicomputer data transfers in response to user commands according to embodiments of the present disclosure. As illustrated in FIG. 1, system 100 may include a plurality of users, e.g., users 101a and 101b, with associated user devices, e.g., user devices 103a and 103b. For example, users 101a and 101b may interact with associated user devices 103a and 103b using one or more input devices (such as a touchscreen, one or more buttons, or the like) and by receiving graphical, aural, or other notifications from the user devices 103a and 103b.

As further depicted in FIG. 1, system 100 may include a plurality of account servers, e.g., account servers 107a and 107b, communicably connected to user devices, e.g., user devices 103a and 103b, through one or more networks, e.g., network 105. Moreover, each account server may be associated with one or more account databases. For example, account server 107a is associated with account database 109a, and account server 107b is associated with account database 109b. Each account database may store account identifiers in association with details of the account, such as transactions posted to and/or pending for the account, identification information of an owner of the account (such as a name, a social security number, a physical address, an email address, a phone number, or the like), or the like. In some embodiments, the account databases may be encrypted such that credentials are required to access at least some information in the databases.

System 100 may be used to perform multicomputer data transferring according to the present disclosure. For example, as depicted in FIG. 1, a command from a user device, e.g., user device 103a, may initiate a multicomputer data transfer from one account server to another account server. In response to the command, one of the account servers may send an inquiry to another user device, e.g., user device 103b, to request authorization of the transfer represented by the command. For example, the data transfer may occur between an account server storing an account associated with a user of the user device submitting the command, e.g., user 101a, and an account server storing an account associated with a user of the user device receiving the inquiry, e.g., user 101b.

Although FIG. 1 depicts two account servers, any number of account servers may be included in system 100. Moreover, although FIG. 1 depicts each account server as having a single account database, each account server may have any number of associated account databases. Indeed, in some embodiments, a plurality of account servers may operate in tandem to provide a distributed account database. Additionally, although FIG. 1 depicts two user devices, any number of user devices may be included in system 100. Moreover, although FIG. 1 depicts each user device as having a single associated user, a plurality of users may share a user device and/or a user may have a plurality of associated user devices.

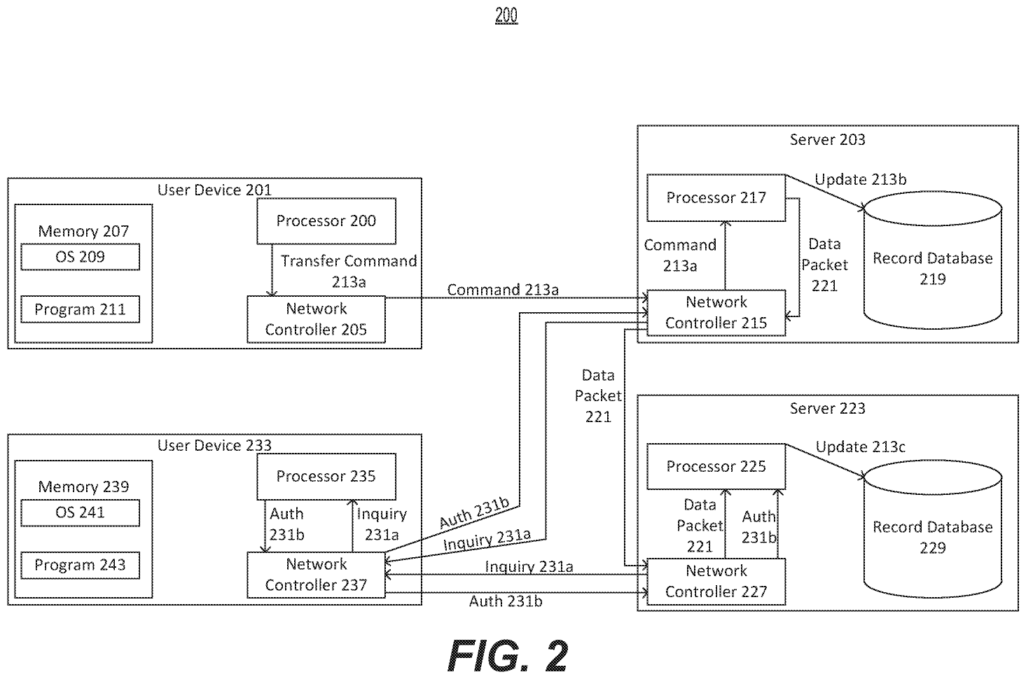

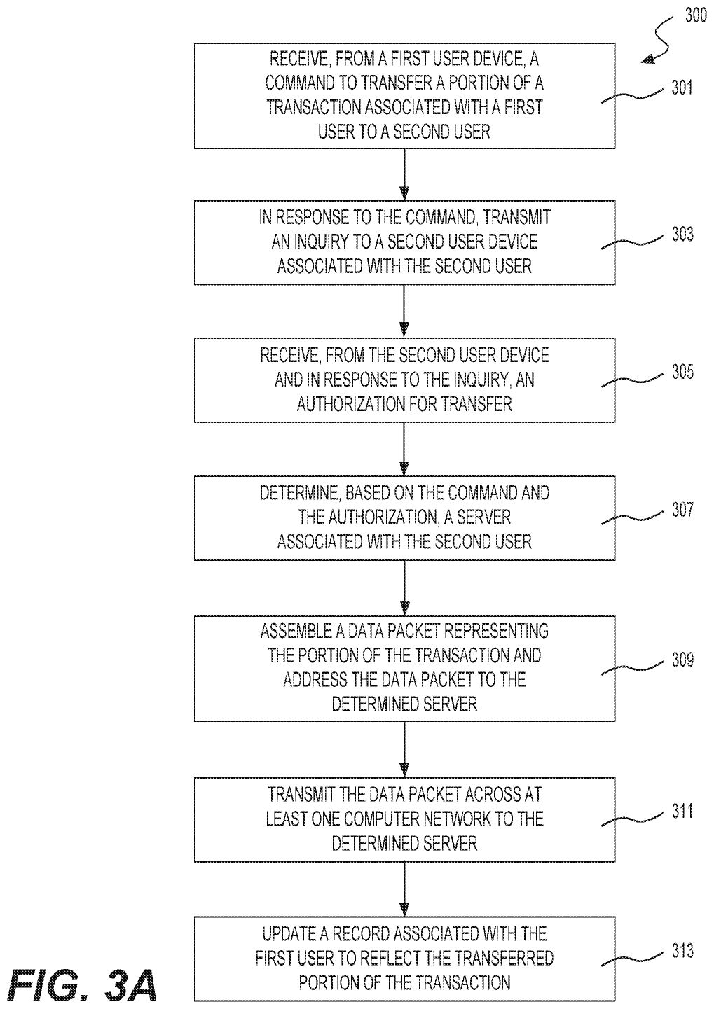

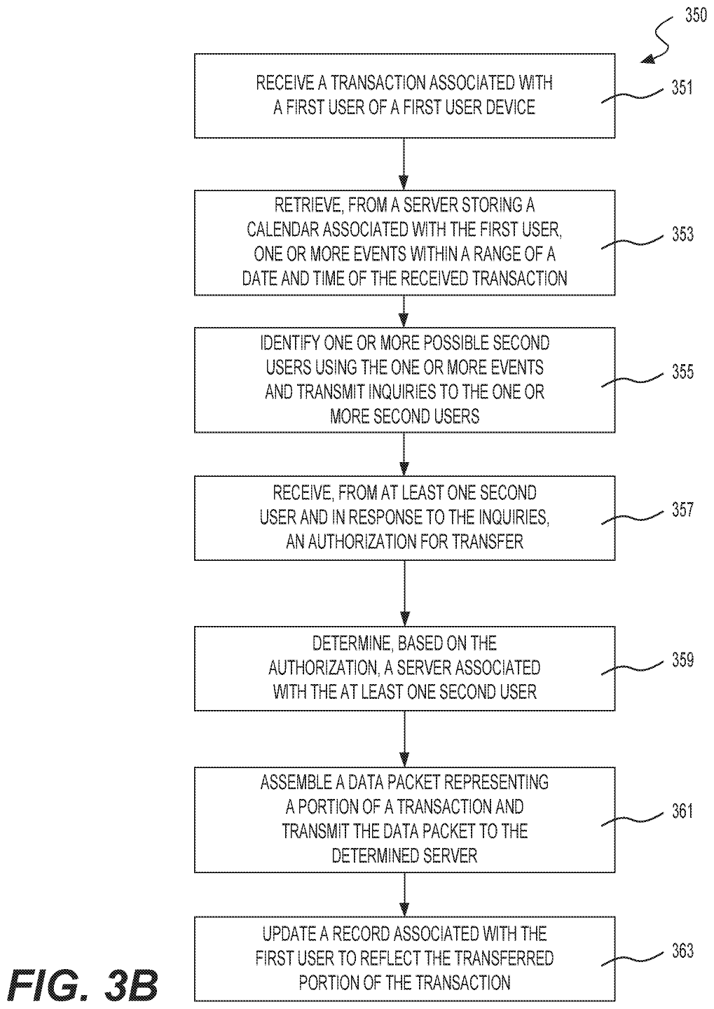

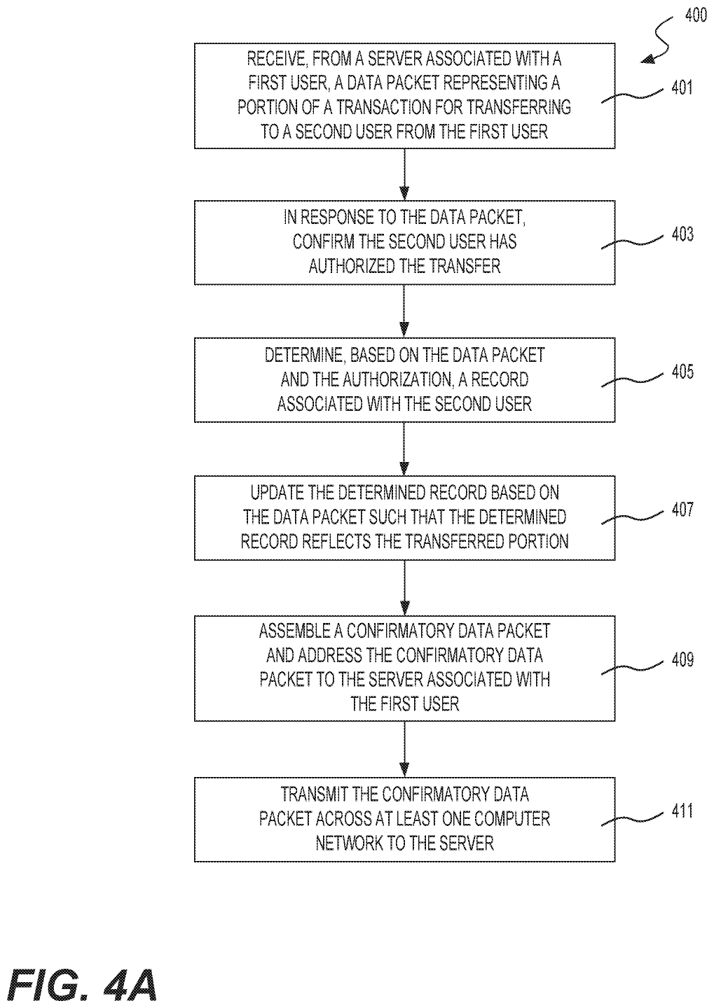

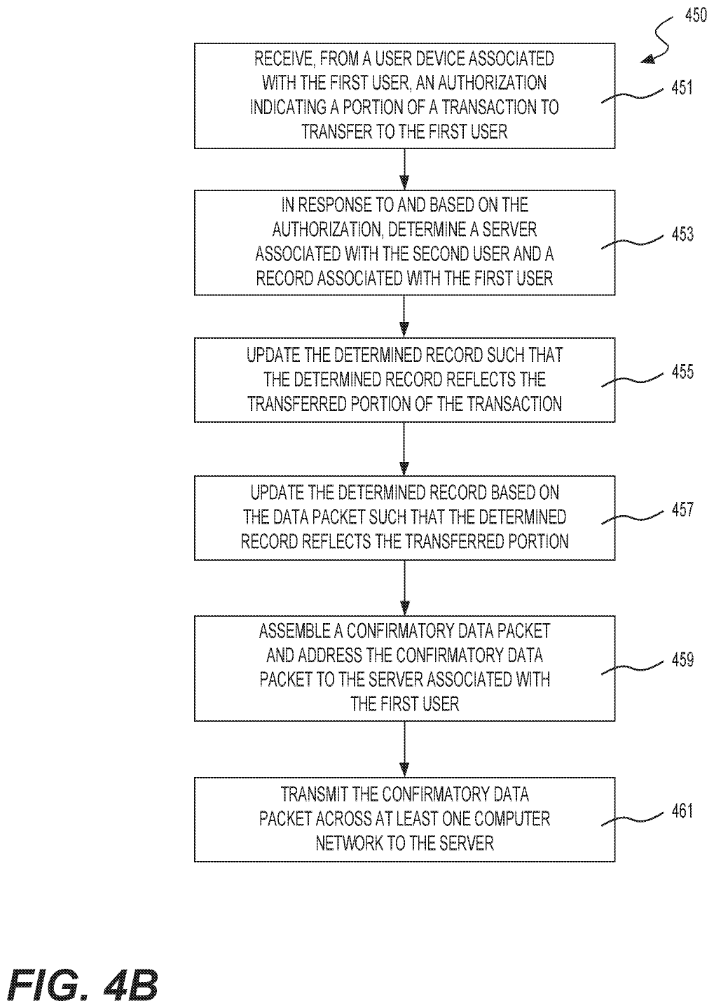

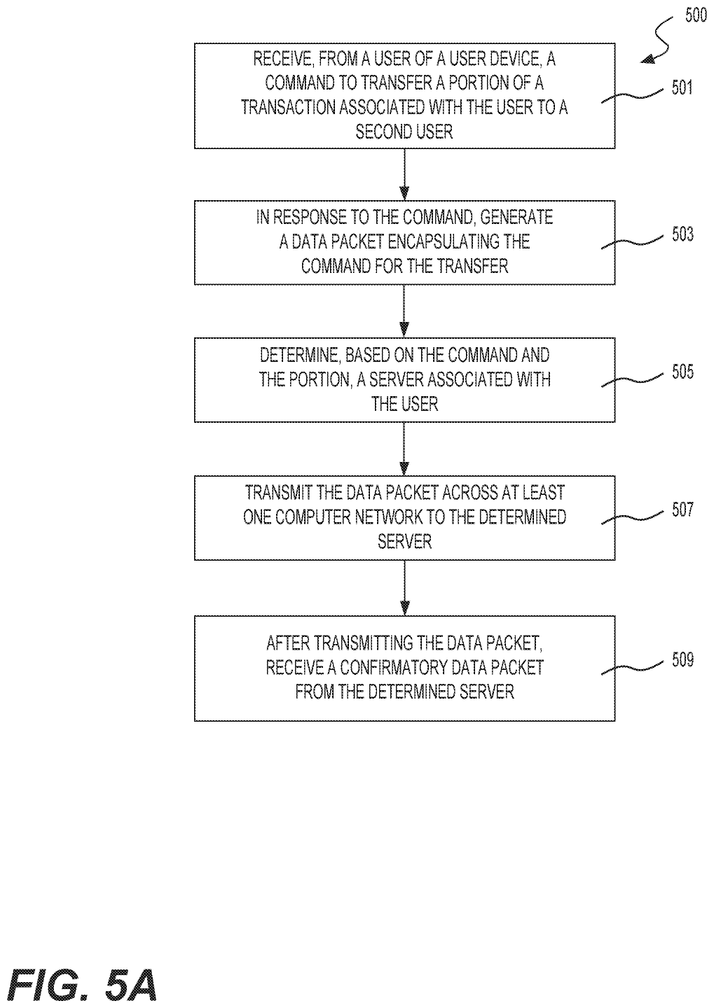

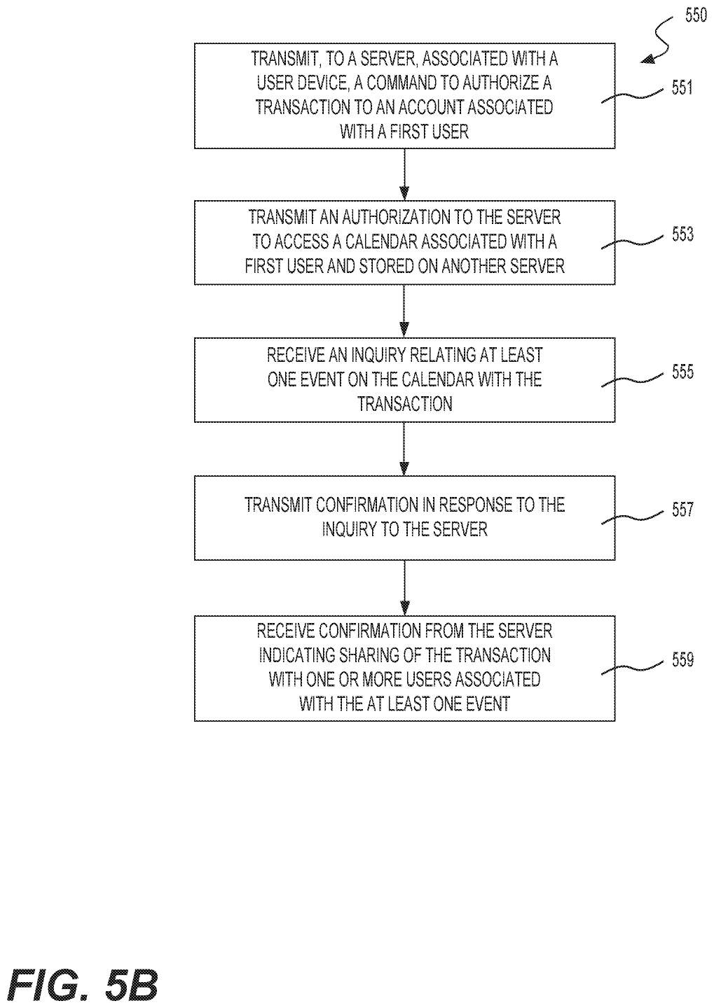

FIG. 2 shows a block diagram of a multicomputer exchange 200 between two servers. For example, exchange 200 may be effected using method 300 of FIG. 3, method 400 of FIG. 4, method 500 of FIG. 5, or a combination thereof. One or ordinary skill will understand that the arrangement of FIG. 2 is exemplary; other arrangements may be used to perform the same functions as described herein. User devices 201 and 233 may comprise, for example, user devices 103a and 103b of FIG. 1. Similarly, servers 203 and 223 may comprise account servers 107a and 107b of FIG. 1.

As depicted in FIG. 2, a user device 201 may include a memory 207 (e.g., a volatile memory such as dynamic random access memory (DRAM), static random access memory (SRAM), or the like and/or a non-volatile memory such as a hard disk drive, a flash memory, or the like) storing an operating system 209 and one or more programs 211. For example, the programs 211 may configure user device 201 to execute method 500 of FIG. 5, described below. Additionally or alternatively, programs 211 may receive input from a user of user device 201 that cause processor 200 to generate, e.g., command 213a, as described below. Furthermore, programs 211 may provide alerts to a user of user device 201 in response to confirmations received from server 203 and/or server 223, as described below. Operating system 209 may comprise, for example, a Windows®, Linux®, or other operating system configured to manage the hardware of user device 201.

User device 201 may further include a processor 200. Processor 200 may generate a command 213a to initiate a transfer of a portion of a transaction from one user to another user. For example, processor 200 may generate command 213a in response to user input indicating a portion of a transaction to send to another user, who may be identified using a username, a phone number, an email address, or the like. For example, as explained above, command 213a may comprise an API call to server 203.

As further depicted in FIG. 2, network controller 205 may transmit the command across one or more computer networks to server 203, where network interface controller 215 receives command 213a and forwards command 213a to processor 217 for processing. In response to receiving command 213a, processor 217 may forward command 213a (as data packet 221) to server 223, where it is received by network controller 227. Concurrently with forwarding command 213a, processor 217 may store an update 213b in record database 219 stored on or otherwise associated with server 203. For example, update 213b may comprise an update to a record in record database 219 associated with an account including the transaction. Accordingly, the update may remove the portion to be transferred from the record. In some embodiments (not shown), server 203 may send update 213b to record database 219 only after confirmation is received from server 223 that the transfer to the other user has been completed.

Server 203 may determine to send data packet 221 to server 223 based on a selection of an account of the other user, server 223 storing or otherwise being associated with a record representing the selected account in record database 229. Alternatively, as depicted in FIG. 2, server 203 may send inquiry 231a to a user device 233 associated with the other user. Similar to user device 201, user device 233 may include a memory 239 storing an operating system 241 and one or more programs 243. User device 233 may receive inquiry 231a and respond with an authorization 231b if the other user approves the transfer of the portion of the transaction via input to user device 233. In such embodiments, server 203 may forward authorization 231b to server 223 as a portion of data packet 221.

Additionally or alternatively, in response to receiving data packet 221, server 223 may transmit an inquiry 231a to user device 233, which may respond with an authorization 231b if the other user approves the transfer of the portion of the transaction via input to user device 233.

In response to receiving authorization 231b, server 223 may store an update 213c in record database 229 stored on or otherwise associated with server 223. For example, update 213c may comprise an update to a record stored in or a new record for storing in record database 229 associated with an account selected by the other user for receipt of the transferred portion of the transaction. Accordingly, the update may add the portion to be transferred to the record.

Server 223 may transmit a confirmatory data packet to server 203 (not shown). Accordingly, server 203 may effect update 213b in response to receiving command 213a, authorization 231b, or the confirmatory data packet. Moreover, server 203 and/or server 223 may transmit confirmations to user device 201 and/or user device 233. The confirmations may confirm to the users that the transfer of the portion of the transaction was completed between server 203 and server 223.

FIG. 3A shows a flowchart of an exemplary multicomputer data exchange process 300, consistent with certain embodiments of the present disclosure. Method 300 may be implemented using at least one processor, such as processor 601 of server 600 of FIG. 6.

At step 301, the at least one processor may receive, from a first user device, a command to transfer a portion of a transaction associated with a first user of the first user device to a second user. For example, as explained above with respect to FIG. 1, user device 103a may send the command to trigger a multicomputer data transfer between account server 107a and account server 107b.

At step 303, in response to the command, the at least one processor may transmit an inquiry to a second user device associated with the second user. For example, as explained above with respect to FIG. 1, account server 107a may send the inquiry to user device 103b.

At step 305, the at least one processor may receive, from the second user device and in response to the inquiry, an authorization for transfer. For example, as explained above with respect to FIG. 1, account server 107a may receive the authorization from user device 103b.

At step 307, the at least one processor may determine, based on the command and the authorization, a server associated with the second user. For example, as explained above, the at least one processor may determine the server based on a location of a record associated with the second user. The record may be associated with an account selected by the second user and included in the authorization.

At step 309, the at least one processor may assemble a data packet representing the portion of the transaction and address the data packet to the determined server. At step 311, the at least one processor may transmit the data packet across at least one computer network to the determined server. For example, as explained above with respect to FIG. 1, account server 107a may send the data packet to account server 107b to effect the transfer of the portion of the transaction.

At step 313, the at least one processor may update a record associated with the first user and stored on the at least one server of the system to reflect the transferred portion of the transaction. For example, as explained above, the at least one processor may update the record to remove the portion of the transaction from an account of the first user represented by the record.

Alternatively, as explained above, method 300 may be further automated. For example, FIG. 3B shows a flowchart of an exemplary automated multicomputer data exchange process 350, consistent with certain embodiments of the present disclosure. Method 350 may be implemented using at least one processor, such as processor 601 of server 600 of FIG. 6.

At step 351, the at least one processor may receive a transaction associated with a first user of a first user device. For example, the at least one processor may receive an API call from the first user device including details of a transaction. The API call may further include a key, a credential, or other authentication that the at least one processor may use to verify the identity of the first user device. In some embodiments, a point-of-sale system may transmit the transaction rather than the first user device.

At step 353, the at least one processor may retrieve, from a server storing a calendar associated with the first user, one or more events within a range of a date and time of the received transaction. For example, the at least one processor may send an API call to the server storing the calendar indicated the range and receive one or more data packets including data related to the one or more events (such as a date, a start time, an end time, a title, one or more attendees, or the like) in response. The API call may further include a key, a credential, or other authentication that the server storing the calendar may use to verify the identity of the at least one processor. For example, the at least one processor may retrieve, from storage, the key, credential, or authentication that was previously provided by the first user to the at least one processor.

At step 355, the at least one processor may identify, using the one or more events, one or more possible second users for sharing the received transaction and transmit inquiries to one or more second user devices associated with the one or more possible second users, the inquiries including a total of the received transaction. For example, the at least one processor may extract attendees from the one or more events. The attendees may comprise names, phone numbers, email addresses, usernames, or the like. Accordingly, the at least one processor may send inquiries to the extracted phone numbers and/or email addresses as text messages and emails, respectively, and/or may determine second user devices associated with attendees based on names, usernames, or the like and send inquiries to the second user device, e.g., using API calls to applications on the second user devices.

At step 357, the at least one processor may receive, from at least one second user device associated with at least one second user and in response to the inquiries, an authorization for transfer, the authorization including an indicator of a portion of the transaction. For example, the authorization may comprise a data packet sent to the at least one processor in response to the inquiry. For example, the inquiries may cause an alert to be displayed to the at least one second user, and the at least one second user may enter a selection of an account associated with the at least one user that is included in the authorization.

At step 359, the at least one processor may determine, based on the authorization, a server associated with the at least one second user. For example, based on the selection of an account in included in the authorization, the at least one processor may determine the server by identifying a server storing a record with data associated with the account.

At step 361, the at least one processor may assemble a data packet representing the portion of the transaction and address the data packet to the determined server and transmit the data packet across at least one computer network to the determined server. For example, the data packet may comprise a header including an address of the determined server and a body including an indicator of the transaction as well as the portion. In some embodiments, the data packet may comprise an API call to the determined server.

At step 363, the at least one processor may update a record associated with the first user and stored on the at least one server of the system to reflect the transferred portion of the transaction. For example, the record may be associated with an account of the first user. Accordingly, the record may be updated by removing the transferred portion of the transaction from the account. For example, as explained above, an amount of the transaction as stored in the record may be reduced by the portion of the transaction and/or a data structure defining the portion of the transaction that was transferred may be appended to the record. In some embodiments, the record may be updated in response to receipt of a confirmatory data packet from the determined server.

FIG. 4A shows a flowchart of an exemplary multicomputer data exchange process 400, consistent with certain embodiments of the present disclosure. Method 400 may be implemented using at least one processor, such as processor 601 of server 600 of FIG. 6. Although depicted separately, method 400 may represent a complementary process to method 300 of FIG. 3A. For example, method 300 may be executed by one server and method 400 executed by another server such that, in combination, a multicomputer data transfer between the server executing method 300 and the server executing method 400 may be effected.

At step 401, the at least one processor may receive, from a server associated with a first user, a data packet representing a portion of a transaction for transferring to a second user from the first user. For example, as explained above with respect to FIG. 1, account server 107b may receive the data packet from account server 107a.

At step 403, in response to the data packet, the at least one processor may confirm the second user has authorized the transfer. For example, the at least one processor may verify an authorization included in the data packet and/or send an inquiry to a second user device associated with the second user and receive an authorization from the second user device in response.

At step 405, the at least one processor may determine, based on the data packet and the authorization, a record associated with the second user. For example, as explained above, the authorization may include a selection of an account associated with the second user, and the at least one processor may determine the record associated with the selected account.

At step 407, the at least one processor may update the determined record based on the data packet such that the determined record reflects the transferred portion of the transaction. For example, as explained above, the at least one processor may update the record to add the portion of the transaction to an account of the second user represented by the record.

At step 409, the at least one processor may assemble a confirmatory data packet and address the confirmatory data packet to the server associated with the first user. At step 411, the at least one processor may transmit the confirmatory data packet across at least one computer network to the server associated with the first user.

Alternatively, as explained above, method 400 may be further automated. For example, FIG. 4B shows a flowchart of an exemplary automated multicomputer data exchange process 450, consistent with certain embodiments of the present disclosure. Method 450 may be implemented using at least one processor, such as processor 601 of server 600 of FIG. 6. Although depicted separately, method 450 may represent a complementary process to method 350 of FIG. 3B. For example, method 350 may be executed by one server and method 450 executed by another server such that, in combination, a multicomputer data transfer between the server executing method 350 and the server executing method 450 may be effected.

At step 451, the at least one processor may receive, from a user device associated with the first user, an authorization including an indicator of a portion of a transaction for transferring from a second user to the first user. For example, as explained above, the authorization may comprise a data packet sent to the at least one processor in response to an inquiry from the at least one processor or from another server. In some embodiments, the authorization may further include an indicator of an account associated with the first user for receiving the transfer and a key, a password, or other credential that may be used by the at least one processor to verify the identity of the user device.

At step 453, in response to and based on the authorization, the at least one processor may determine a server associated with the second user and a record associated with the first user. For example, as explained above, based on the selection of an account in included in the authorization, the at least one processor may determine the server by identifying a server storing a record with data associated with the account. Similarly, based on an account associated with the first user that includes the transaction, the at least one processor may determine the record storing data associated with the account.

At step 455, the at least one processor may update the determined record based on the authorization such that the determined record reflects the transferred portion of the transaction. For example, as explained above, the at least one processor may add a new transaction to the record, the new transaction reflecting the portion of the transaction.

At step 457, the at least one processor may assemble a confirmatory data packet and address the confirmatory data packet to the determined server. At step 459, the at least one processor may transmit the confirmatory data packet across at least one computer network to the server associated with the second user.

FIG. 5A shows a flowchart of an exemplary process 500 for causing multicomputer data transferring using a user device, consistent with certain embodiments of the present disclosure. Method 500 may be implemented using at least one processor of the user device, such as processor 705 of user device 700 of FIGS. 7A and 7B. Although depicted separately, method 500 may represent a complementary process to method 300 of FIG. 3. For example, method 500 may be executed by the user device and method 300 executed by a server (e.g., server 600 of FIG. 6) such that, in combination, the user device executing method 500 causes the server executing method 300 to perform a multicomputer data transfer.

At step 501, the at least one processor may receive, from a user of the user device, a command to transfer a portion of a transaction associated with the user to a second user. For example, the command may be generated in response to input from the user indicating the portion of the transaction to be transferred and indicating at least one second user for whom the transfer is intended. The at least one second user may be indicated using a username, a phone number, an email address, or the like.

At step 503, in response to the command, the at least one processor may generate a data packet encapsulating the command for the transfer. For example, the at least one processor may generate an API call for execution by the server determined in step 505.

At step 505, the at least one processor may determine, based on the command and the portion, a server associated with the user and including, in at least one record, the transaction. For example, as explained above, the command may include a selection of the transaction, and the at least one processor may determine an account of the first user including the transaction and determine the server storing a record representing the determined account.

At step 507, the at least one processor may transmit the data packet across at least one computer network to the determined server. For example, as explained above with respect to FIG. 1, user device 103a may transmit the command to account server 107a. At step 509, after transmitting the data packet, the at least one processor may receive a confirmatory data packet from the determined server, the confirmatory data packet indicating completion of the requested transfer.

Alternatively, as explained above, method 500 may be further automated. For example, FIG. 5B shows a flowchart of an exemplary process 550 for authorization automated multicomputer data transferring using a user device, consistent with certain embodiments of the present disclosure. Method 550 may be implemented using at least one processor of the user device, such as processor 705 of user device 700 of FIGS. 7A and 7B. Although depicted separately, method 550 may represent a complementary process to method 350 of FIG. 3. For example, method 550 may be executed by the user device and method 350 executed by a server (e.g., server 600 of FIG. 6) such that, in combination, the user device executing method 550 causes the server executing method 350 to perform a multicomputer data transfer.

At step 551, the at least one processor may transmit, to a server associated with the user device, a command to authorize a transaction to an account associated with a first user. For example, the at least one processor may transmit an API call from the first user device including details of a transaction. The API call may further include a key, a credential, or other authentication that the at least one processor may use to verify the identity of the user device. In some embodiments, a point-of-sale system may transmit the transaction rather than the user device.

At step 553, the at least one processor may transmit an authorization to the server to access a calendar associated with the first user stored on another server. For example, the authorization may comprise a key, a credential, or other authentication that the server may use to access the calendar, e.g., via an API call.

At step 555, the at least one processor may receive an inquiry relating at least one event on the calendar with the transaction. For example, the at least one processor may receive an API to an application executed by the at least one processor such that an alert may be presented to the first user.

At step 557, the at least one processor may transmit confirmation in response to the inquiry to the server. For example, the user may input confirmation of the relation between the at least one event and the transaction in response to the alert, e.g., using a touchscreen or other input device. Alternatively, the user may confirm a relation between one event and the transaction and deny a relation between another event and the transaction. Accordingly, the confirmation may correct, at least in part, the relation included in the inquiry.

At step 559, the at least one processor may receive confirmation from the server, the confirmation indicating sharing of the transaction with one or more users associated with the at least one event. For example, the confirmation may be displayed to the first user via the user device.

FIG. 6 is block diagram of an example device 600 suitable for implementing the disclosed systems and methods. For example, device 600 may comprise a server that executes method 300 of FIG. 3 and/or method 400 of FIG. 4.

As depicted in FIG. 6, server 600 may have a processor 601. Processor 601 may comprise a single processor or a plurality of processors. For example, processor 601 may comprise a CPU, a GPU, a reconfigurable array (e.g., an FPGA or other ASIC), or the like.

Processor 601 may be in operable connection with a memory 603, an input/output module 605, and a network interface controller (NIC) 607. Memory 603 may comprise a single memory or a plurality of memories. In addition, memory 603 may comprise volatile memory, non-volatile memory, or a combination thereof. As depicted in FIG. 6, memory 603 may store one or more operating systems 609 and program instructions for multicomputer transferring 611. For example, instructions 611 may cause server 600 to execute method 300 of FIG. 3 and/or method 400 of FIG. 4. In addition, memory 603 may store data 613 produced by, associated with, or otherwise unrelated to operating system 609 and/or instructions for multicomputer transferring 611.

Input/output module 605 may store and retrieve data from one or more databases 615. For example, database(s) 615 may include records associated with one or more users, at least one of which is updated in accordance with execution of method 300 of FIG. 3 and/or method 400 of FIG. 4.

NIC 607 may connect server 600 to one or more computer networks. In the example of FIG. 6, NIC 607 connects server 600 to the Internet. Server 600 may receive data and instructions over a network using NIC 607 and may transmit data and instructions over a network using NIC 607.

Each of the above identified instructions and applications may correspond to a set of instructions for performing one or more functions described above. These instructions need not be implemented as separate software programs, procedures, or modules. Disclosed memories may include additional instructions or fewer instructions. Furthermore, server 600 may receive commands from a user device executing method 500 of FIG. 5 and/or authorizations from other user devices. Accordingly, server 600 may execute method 300 of FIG. 3 and/or method 400 of FIG. 4. These functions of the user device and/or server 600 may be implemented in hardware and/or in software, including in one or more signal processing and/or application specific integrated circuits.

FIG. 7A is a depiction of exemplary user device 700 for use in causing multicomputer data transferring. As depicted in FIG. 7A, device 700 may comprise a smartphone. Device 700 may have a screen 701. For example, screen 701 may display one or more GUIs that allow a user to enter input causing multicomputer data transferring, e.g., in accordance with method 500 of FIG. 5. In certain aspects, screen 701 may comprise a touchscreen to facilitate use of the one or more GUIs.

As further depicted in FIG. 7A, device 700 may have one or more buttons, e.g., buttons 703a and 703b. For example, buttons 703a and 703b may facilitate use of one or more GUIs displayed on screen 701.

FIG. 7B is a side view of device 700 of FIG. 7A. As depicted in FIG. 7B, device 700 may have at least one processor 705. For example, at least one processor 705 may comprise a system-on-a-chip (SOC) adapted for use in a portable device, such as device 700. Alternatively or concurrently, at least one processor 705 may comprise any other type(s) of processor.

As further depicted in FIG. 7B, device 700 may have one or more memories, e.g., memories 707a and 707b. In certain aspects, some of the one or more memories, e.g., memory 707a, may comprise a volatile memory. In such aspects, memory 707a, for example, may store one or more applications (or “apps”) for execution on at least one processor 705. For example, an app may include an operating system for device 700 and/or an app for executing method 500 of FIG. 5. In addition, memory 707a may store data generated by, associated with, or otherwise unrelated to an app in memory 707a.

Alternatively or concurrently, some of the one or more memories, e.g., memory 707b, may comprise a non-volatile memory. In such aspects, memory 707b, for example, may store one or more applications (or “apps”) for execution on at least one processor 705. For example, as discussed above, an app may include an operating system for device 700 and/or an app for executing method 400 of FIG. 4 and/or method 500 of FIG. 5. In addition, memory 707b may store data generated by, associated with, or otherwise unrelated to an app in memory 707b. Furthermore, memory 707b may include a pagefile, swap partition, or other allocation of storage to allow for the use of memory 707b as a substitute for a volatile memory if, for example, memory 707a is full or nearing capacity.

Although depicted as a smart phone, device 700 may alternatively comprise a tablet or other computing device having similar components.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented with hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive.

Instructions or operational steps stored by a computer-readable medium may be in the form of computer programs, program modules, or codes. As described herein, computer programs, program modules, and code based on the written description of this specification, such as those used by the processor, are readily within the purview of a software developer. The computer programs, program modules, or code can be created using a variety of programming techniques. For example, they can be designed in or by means of Java, C, C++, assembly language, or any such programming languages. One or more of such programs, modules, or code can be integrated into a device system or existing communications software. The programs, modules, or code can also be implemented or replicated as firmware or circuit logic.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

1. A system for multicomputer data transferring in response to user input, the system comprising at least one server, the at least one server comprising:
at least one memory storing instructions; and
at least one processor configured to execute the instructions to perform operations comprising:
receiving from a first user device, a command to transfer a portion of a transaction associated with a first user of the first user device to a second user;
in response to the command, transmitting an inquiry to a second user device associated with the second user;
receiving, from the second user device and in response to the inquiry, an authorization for transfer;
determining, based on the command, a server associated with the second user;
transmitting the authorization to the server associated with the second user;
assembling a data packet representing the portion of the transaction and addressing the data packet to the server associated with the second user;
transmitting the data packet across at least one computer network to the server associated with the second user;
updating a record associated with the first user;
storing the updated record on the at least one server of the system to reflect the transferred portion of the transaction,
generating a first confirmation based on the updated record;
transmitting the first confirmation to the server associated with the second user;
receiving a second confirmation, generated by the server associated with the second user based on the first confirmation, indicating that record associated with the second user was updated and stored;
generating a third confirmation based on the first confirmation and the second confirmation; and
transmitting the third confirmation to the first user device, indicating that transfer has been completed, wherein third confirmation causes the first user device to display at least one of a push alert, a graphical alert, or other type of alert.

2. The system of claim 1, wherein the inquiry comprises an application programming interface (API) call to an application executed by the second user device.

3. The system of claim 1, wherein the authorization includes a selection of a record stored on the determined server for updating to reflect the transfer.

4. The system of claim 3, wherein the assembled data packet includes:
a header including an address of the server associated with the second user, and
a body including an indicator of the selected record and an indicator of the portion of the transaction.

5. The system of claim 1, wherein the assembled data packet includes an authentication of the at least one server.

6. The system of claim 5, wherein the authentication comprises an authentication provided by the second user in the authorization.

7. The system of claim 5, wherein the authentication comprises an authentication previously provided from the server associated with the second user to the at least one server.

8. The system of claim 1, wherein the operations further comprise:
determining, based on an identity of the second user, whether the second user has an associated record of a first type;
when the second user has an associated record of the first type, determining a first set of records of the first type stored on the server associated with the second user for updating to reflect the transfer; and
when the second user does not have an associated record of the first type, determining a second set of records not of the first type stored on the determined server for updating to reflect the transfer.

9. The system of claim 8, wherein the first set of records of the first type represents a plurality of accounts having an associated account servicer that is the same as an associated account servicer of an account represented by the record associated with the first user.

10. The system of claim 8, wherein the second set of records not of the first type represents a plurality of accounts having an associated account servicer that is not the same as an associated account servicer of an account represented by the record associated with the first user.

11. A system for multicomputer data transferring in response to user input, the system comprising at least one server, the at least one server comprising:
at least one memory storing instructions; and
at least one processor configured to execute the instructions to perform operations comprising:
receiving, from a server associated with a first user, a data packet representing a portion of a transaction for transferring to a second user from the first user;
in response to the data packet, confirming the second user has authorized the transfer;
receiving a confirmation from the server associated with the first user, indicating that record associated with the first user was updated and stored;
determining, based on the data packet and the authorization, a record associated with the second user;
updating the determined record based on the data packet and the received confirmation, wherein the determined record reflects the transferred portion of the transaction;
based on the received confirmation and updated record assembling a confirmatory data packet;
addressing the confirmatory data packet to the server associated with the first user; and
transmitting the confirmatory data packet across at least one computer network to the server associated with the first user, causing the server associated with the first user to acknowledge that the record associated with the second user was updated and stored.

12. The system of claim 11, wherein confirming the second user has authorized the transfer comprises:
generating an inquiry and transmitting the inquiry to a second user device associated with the second user; and
receiving, from the second user device and in response to the inquiry, the authorization.

13. The system of claim 12, wherein the authorization includes an authentication associated with the second user.

14. The system of claim 13, wherein the authentication comprises an authentication input by the second user into the second user device.

15. The system of claim 13, wherein the authentication comprises an authentication relationship previously established between an application executed by the second user device and the at least one server.

16. The system of claim 11, wherein the confirmatory data packet is configured to cause the server associated with the first user to transmit a confirmation to a first user device associated with the first user.

17. The system of claim 11, wherein the operations further comprise:
determining, based on an identity of the second user, whether the first user has an associated record of a first type;
when the second user has an associated record of the first type, selecting the associated record of the first type as the determined record; and
when the second user does not have an associated record of the first type, selecting an associated record not of the first type as the determined record.

18. The system of claim 17, wherein the first type comprises accounts having an associated account servicer that is the same as an associated account servicer of an account associated with the first user from which the transfer originated.

19. The system of claim 17, wherein the second type comprises accounts having an associated account servicer that is not the same as an associated account servicer of an account associated with the first user from which the transfer originated.

20. A user device for causing multicomputer data transferring, the user device comprising:
at least one memory storing instructions; and
at least one processor configured to execute the instructions to perform operations comprising:
receiving, from a user of the user device, a command to transfer a portion of a transaction associated with the user to a second user;
in response to the command, generating a data packet encapsulating the command for the transfer;
determining, based on the command and the portion, a server associated with the user and including, in at least one record, data associated with the transaction;
transmitting the data packet across at least one computer network to the determined server;
receiving, from the determined server, an inquiry relating at least one event on a calendar associated with the user device with the transaction;
transmitting confirmation in response to the inquiry to the server associated with the user;
receiving a confirmatory data packet from the determined server, the confirmatory data packet indicating completion of the requested transfer, and
in response to the confirmatory data packet displaying at least one of a push alert, a graphical alert, or other type of alert.
